(19) United States
(12) Patent Application Publication
(10) Pub. No.: US 2004/0075416 A1
(43) Pub. Date: Apr. 22, 2004

(54) PORTABLE POWER SUPPLY

(75) Inventor: Kent T. J. Hsu, Taipei (TW)

Correspondence Address: RABIN & BERDO, P.C., 1101 14 Street, N.W., Suite 500, Washington, DC, 20005, US

(73) Assignee: ASOKA INC., Taipei (TW)

(21) Appl. No.: 10/251,817

(22) Filed: Sep. 23, 2002

(51) Int. Cl. H02J 7/00

(52) U.S. Cl. 320/107

(57) ABSTRACT

A parallelepiped portable power supply comprises a CD-ROM drive, a plurality of drawers, a top fastening mechanism for fastening a video game machine, and a power supply section including a replaceable rechargeable battery for supplying power to the video game machine in outdoors or an environment without power supply.

### FIELD OF THE INVENTION

The present invention relates to power supplies and more particularly to a portable power supply for a GAMECUBE video game machine.

### BACKGROUND OF THE INVENTION

GAMECUBE is the fourth generation video game machine developed by Nintendo, a Japanese company. GAMECUBE is the smallest among the fourth generation video game machines. Typically, a ring is provided on GAMECUBE for being portable. However, such portability of GAMECUBE is much compromised because there is no battery compartment provided for receiving one or more cells for playing GAMECUBE in outdoors or an environment without power supply. Moreover, a number of accessories such as joystick, rechargeable battery, LCD (liquid crystal display), and CDs are required to carry along with the GAMECUBE machine for an outing. This is very inconvenient and may frustrate an enthusiastic user. Hence, a need exists for providing a portable power supply adapted to video game machine, particularly to GAMECUBE video game machine.

### SUMMARY OF THE INVENTION

It is therefore an object of the present invention to provide a portable power supply comprising a top fastening mechanism for fastening a video game machine and a power supply section including a replaceable rechargeable battery or supplying power to the video game machine in outdoors or an environment without power supply.

It is another object of the present invention to provide a portable power supply comprising a CD-ROM drive and a plurality of drawers for storing tools or the like.

The above and other objects, features and advantages of the present invention will become apparent from the following detailed description taken with the accompanying drawings.

### BRIEF DESCRIPTION OF THE DRAWINGS

FIG. 1 is an exploded view of a preferred embodiment of a portable power supply adapted to video game machine according to the invention;

FIG. 2 is a perspective view of power supply shown in FIG. 1 and video game machine mounted thereon;

FIG. 3 is a perspective view of power supply shown in FIG. 1 for depicting a fastening mechanism thereof; and

FIG. 4 is a view similar to FIG. 3 but viewed from an opposite side for depicting a power supply section of the power supply.

### DETAILED DESCRIPTION OF THE PREFERRED EMBODIMENTS

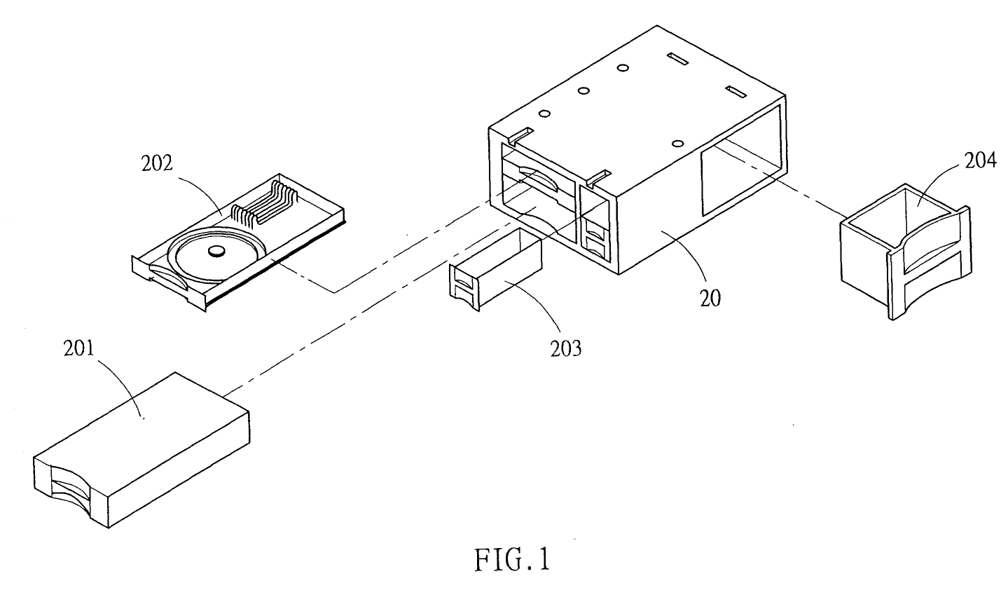

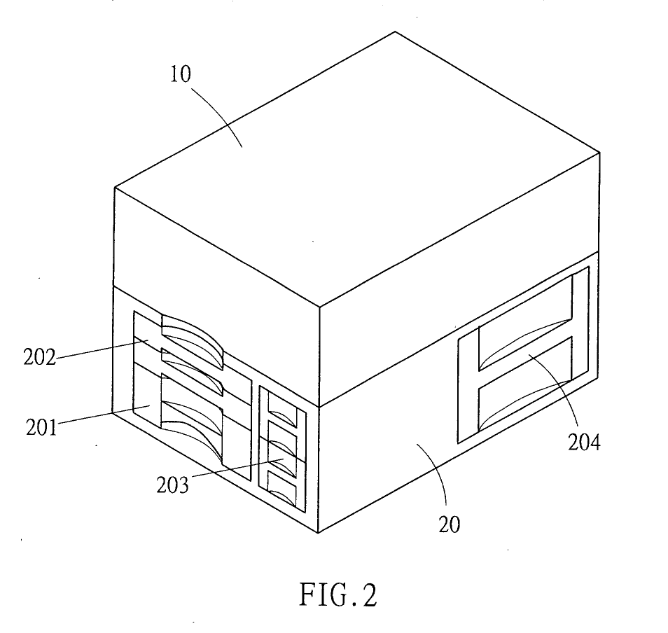

Referring to FIGS. 1 and 2, there is shown a portable power supply constructed in accordance with the invention. This power supply 20 is particularly adapted to GAMECUBE video game machine. The power supply 20 is a parallelepiped with a video game machine 10 mounted thereon. In the power supply 20, at a forward side, there are provided a replaceable rechargeable battery 201 received in one of a plurality of slots thereof, the rechargeable battery 201 being served for supplying power to the video game machine 10 in outdoors, an automobile, or an environment without power supply, a CD-ROM drive 202 retractably received in another slot, a first drawer 203 besides the rechargeable battery 201 and the CD-ROM drive 202 for receiving tools, etc. In one side of the power supply 20 there is provided a second drawer 204 also for receiving tools or the like.

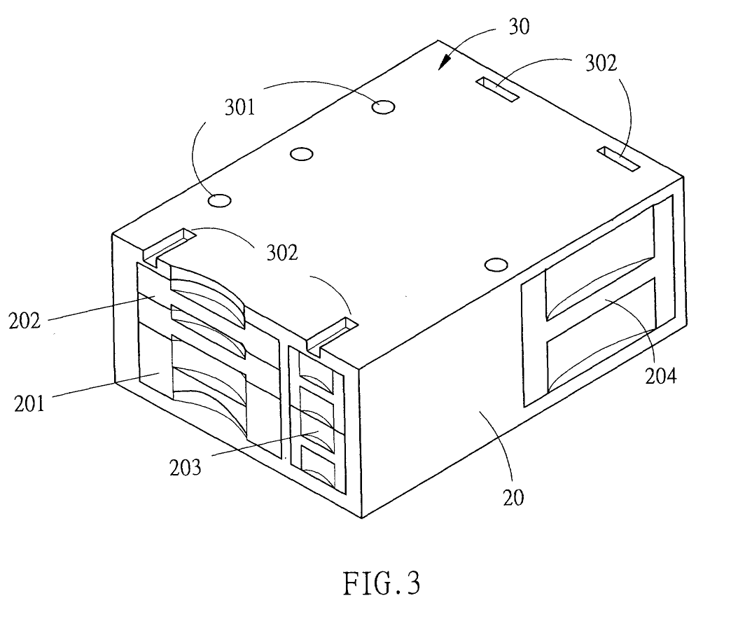

Referring to FIG. 3, the power supply further comprises a top fastening mechanism 30. The fastening mechanism 30 comprises a plurality of holes 301 for permitting threads to drive through for fastening the video game machine 10, and a plurality of slits 302 for fastening a plurality of mating members such as tabs (not shown) on a bottom of the video game machine 10. With such configuration, the video game machine 10 can be secured on top of the power supply 20.

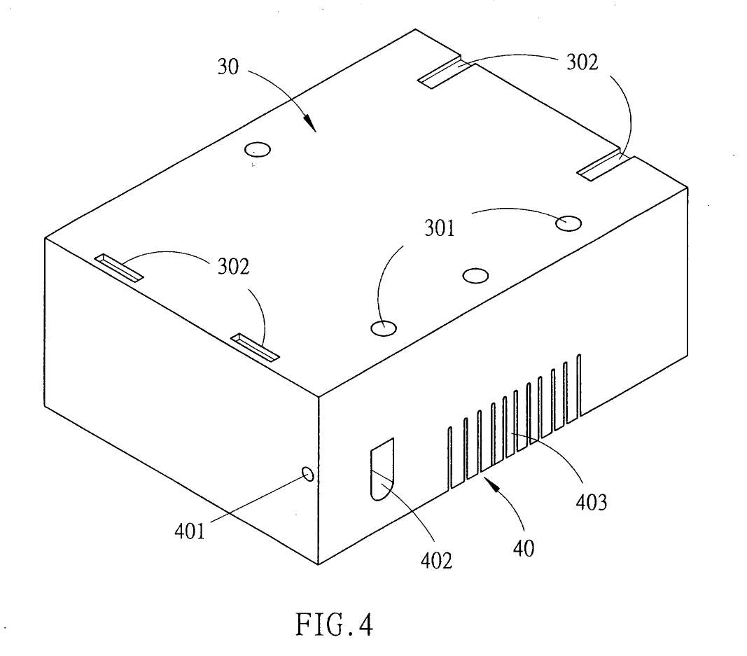

Referring to FIG. 4 in conjunction with FIG. 1, the power supply 20 further comprises a power supply section 40. The power supply section 40, in addition to the rechargeable battery 201, further comprises a power jack 401 for supplying power from the rechargeable battery 201 to the video game machine 10 by coupling a power cord in between, a charger jack 402 for charging the discharged rechargeable battery 201 by coupling a power cord from an external power supply thereto, and a plurality of vent openings 403 for dissipating heat generated by the rechargeable battery 201.

In a case that parents take children for an outing, the parents simply carry the GAMECUBE video game machine 10 along with the portable power supply 20 of the invention, one or more replaceable rechargeable batteries 201, and CDs and necessary tools stored in the first and second drawers 203 and 204. Hence, the invention has the advantages of convenience and compactness in addition to the portability.

While the invention has been described by means of specific embodiments, numerous modifications and variations could be made thereto by those skilled in the art without departing from the scope and spirit of the invention set forth in the claims.

What is claimed is:

1. A parallelepiped portable power supply comprising:
a CD-ROM drive;
a plurality of drawers;
a top fastening mechanism for fastening a video game machine; and
a power supply section for supplying power to the video game machine in outdoors or an environment without power supply.

2. The portable power supply of claim 1, wherein the power supply section comprises a rechargeable battery, a power jack, a charger jack, and a plurality of vent openings for dissipating heat.

3. The portable power supply of claim 1, wherein the fastening mechanism comprises a plurality of holes and a plurality of slits for securing to the video game machine.

4. The portable power supply of claim 2, wherein the rechargeable battery is replaceable.
